(19) United States
(12) Patent Application Publication
(10) Pub. No.: US 2009/0230135 A1
(43) Pub. Date: Sep. 17, 2009

(54) Round rotating cooking pot

(76) Inventor: DAN GHITZA, Bat Yam (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/401,785

(22) Filed: Mar. 11, 2009

Related U.S. Application Data
(60) Provisional application No. 61/035,378, filed on Mar. 11, 2008.

(51) Int. Cl. A47J 27/08

(52) U.S. Cl. 220/573.1; 99/337; 99/340; 99/403

(57) ABSTRACT

The present invention relates to a round rotating cooking pot.

More particularly, the present invention relates to a round rotating cooking pot which enables the user to cook food while moving so that the food that is cooking is separated in the cooking process occasionally from the sidewalls of the pot.

### FIELD OF THE INVENTION

The present invention relates to a round rotating cooking pot.

More particularly, the present invention relates to a round rotating cooking pot which enables the user to cook food while moving so that the food that is cooking is separated in the cooking process occasionally from the sidewalls of the pot.

### BACKGROUND OF THE INVENTION

Other objects and advantages of the invention will become apparent as the description proceeds.

When cooking in a regular cooking pot, frequently the food sticks to the pot in the cooking process as a result of the heat and the ingredients the food is made of.

The pots known up until today were static and the food always stayed in the same place and the cooking heat concentrated at the bottom of the pot.

The object of the present invention is to enable cooking food while rotating the pot in a manner which will not enable the food to stick to the pot and in a manner which the heat source will heat each time a different part of the pot.

### SUMMARY OF THE INVENTION

The present invention relates to a round rotating cooking pot using the force of steam generated in the pot in the cooking process or by the force of an electric engine.

The round rotating cooking pot described in the present invention comprises:

a. A round pot.
b. A rotating and sealed lid.
c. 2 hinges enabling the rotation of the pot.
d. A propelling system operated by steam comprising exhaust pipes.
e. One or more water containers inside the pot.
f. A stand enabling placing the pot above a heat source, such as cooking gas.

The round rotating cooking pot described in the present invention can rotate by the force of the steam coming out of pipes and nozzles which can be regulate the pressure going through them.

According to the present invention the round rotating cooking pot can also operate by electric force using propulsion of an electric engine which receives its electric current from electric batteries or an electric socket.

Basically, the length of time needed for cooking shortens substantially during use of the present invention. Furthermore, due to the scattering of the heat and the movement of the pot during cooking, the food is cooked well, efficiently, equally and more unified.

According to the present invention when the user would like to cook a dish he opens the lid of the pot using indentations located on the lid or in a different manner possible technically, inserts the food to the pot, already inside the pot is water inside the compartments designed to rotate the hinge. The pot is sealed using the lid and the pot is placed on the stove top or a heat source and cooking starts, in the cooking process the pot heats up creating steam that rotates it.

According to one of the preferred embodiments the rotation of the round rotating cooking pot described in the present invention will be done using the steam pressure which was released through the exhaust openings.

According to a different preferred embodiment the round rotating cooking pot described in the present invention will rotate by the mechanical force of an electric engine which receives its electric current from batteries or an electric socket.

### BRIEF DESCRIPTION OF THE DRAWINGS

The present invention will be fully described in FIG. 1 to 6.

These figures are the embodiments of several forms of the present invention with no intention to reduce the embodiment's extent.

The present invention may be better understood in conjunction with the following figures:

FIG. 1 illustrates an isometric schema of use of the round rotating cooking pot according to the present invention.

FIG. 2 illustrates an isometric schema of the round rotating cooking pot using the steam method according to the present invention.

FIG. 3 illustrates an isometric schema in disassembled mode of the round rotating cooking pot in the steam method according to the present invention.

FIG. 4 illustrates a two dimensional schema of a section of the round rotating cooking pot in the steam method according to the present invention.

FIG. 5 illustrates an isometric schema of the round rotating cooking pot using the electric engine method according to the present invention.

FIG. 6 illustrates a two dimensional schema of a section schema of the round rotating cooking pot using the electric engine method according to the present invention.

### DETAILED DESCRIPTION OF THE PREFERRED EMBODIMENT

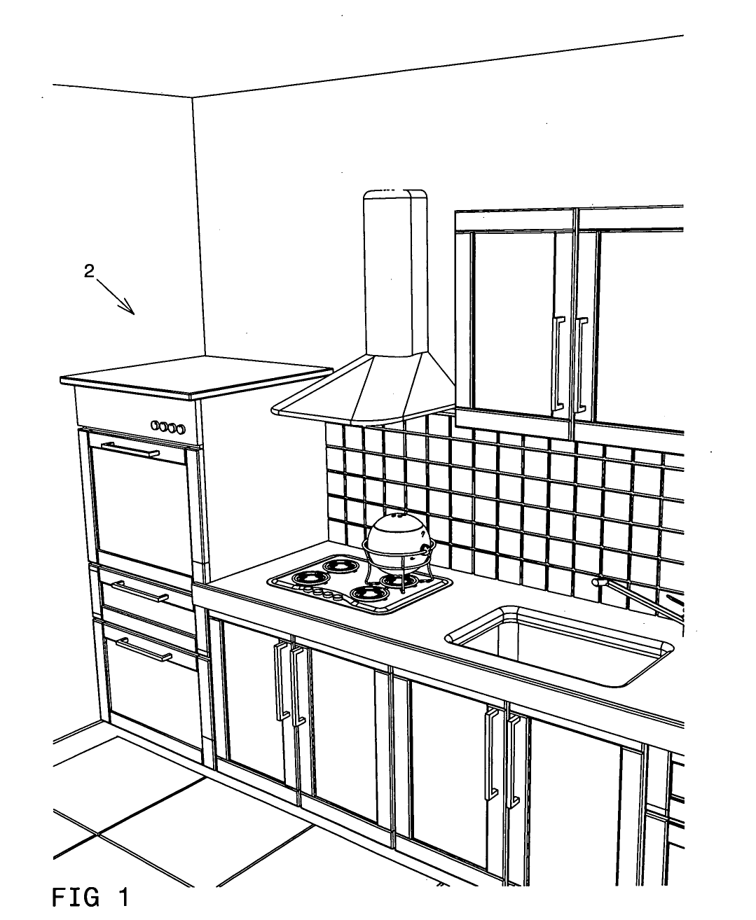

Referring to FIG. 1, illustrates an isometric schema of use of the round rotating cooking pot (2) according to the present invention.

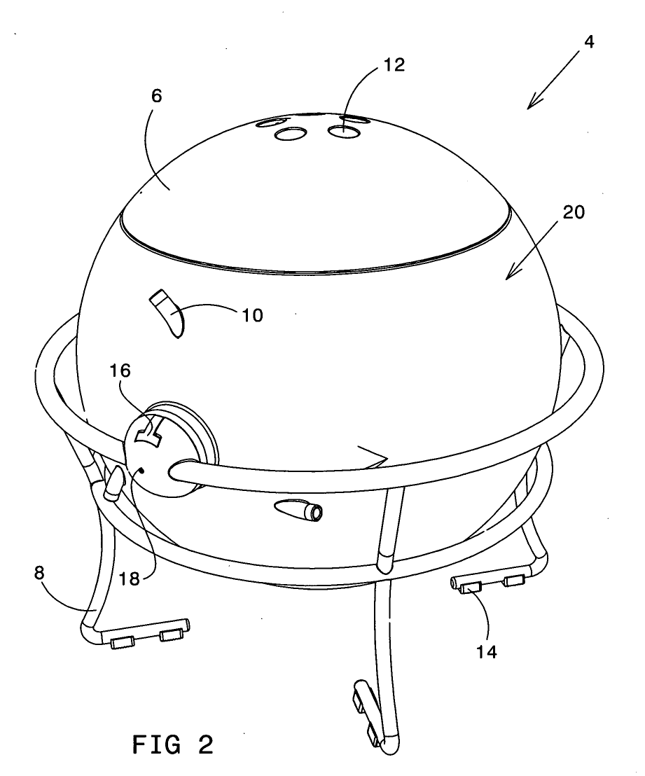

Referring to FIG. 2, illustrates an isometric schema of the round rotating cooking pot using the steam method (4) according to the present invention. In the illustration it is possible to view the body of the cooking pot (20) on which closes the lid (6) in which are holes for the fingers grip (12).

Furthermore, in the body of the pot (20) are pipes for the steam to exit (10) which rotate the pot.

On the rotation axis of the pot is a connector (16) which connects the pot to the connector's foundation (18) which is connected to the pot stand (8). On the bottom part of the pot stand are rubber bases (14) for creating high friction and preventing movement and slipping.

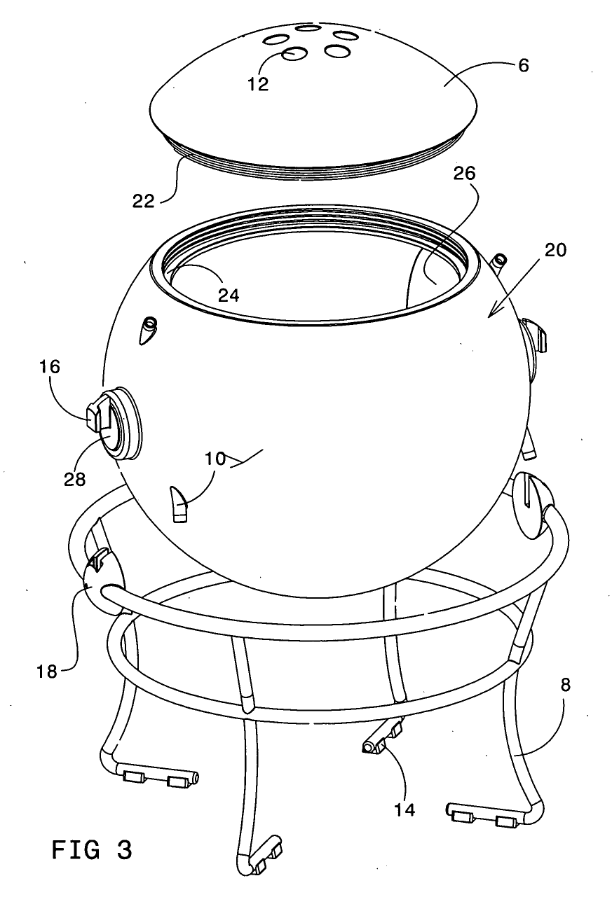

Referring to FIG. 3, illustrates an isometric schema in disassembled mode of the round rotating cooking pot in the steam method according to the present invention.

In the illustration it is possible to view how the lid of the pot (6) in which are holes for the fingers to grip (12) comprising on its bottom part a screwing (22) for hermetic sealing.

Furthermore, it is possible to see in the pot (20) the rubber seal (24), and on the inside of the pot is the side wall of the pot (26).

Also visible are the steam pipes (10) and the bearing (28) on which the connector (16) is assembled which connects to the foundation of the connector (18) which is an integral part of the pot stand (8), which assembled on its legs are rubber bases for creating high friction and preventing movement and slipping (14).

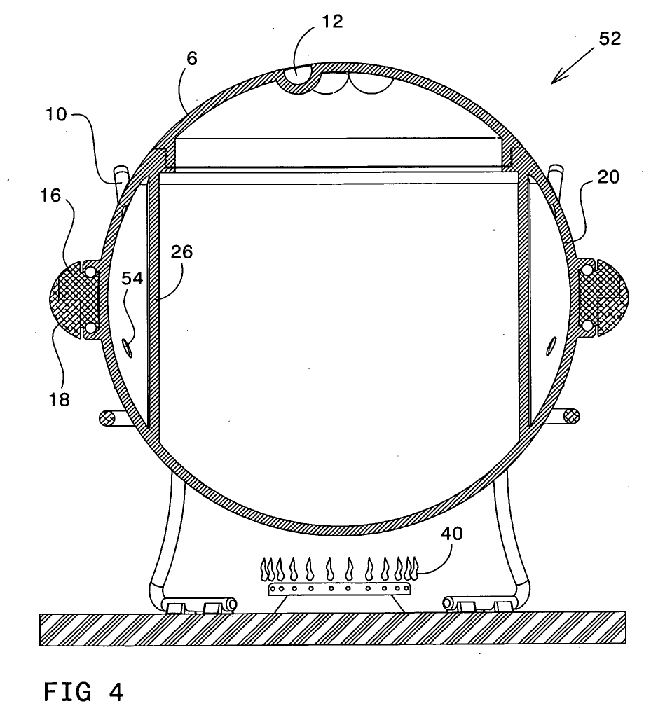

Referring to FIG. 4, illustrates a two dimensional schema of a section of the round rotating cooking pot in the steam method (52) according to the present invention.

In the illustration the pot (20) is set above a fire flame (40). The connector of the pot (16) connects to the foundation (18).

Furthermore, it is possible to view the sidewalls of the pot (26) and in them openings for the steam to exit (54) from which comes out the steam through the steam exit pipe (10).

Furthermore, the pot is covered by lid (6) comprising holes for the fingers to grip (12).

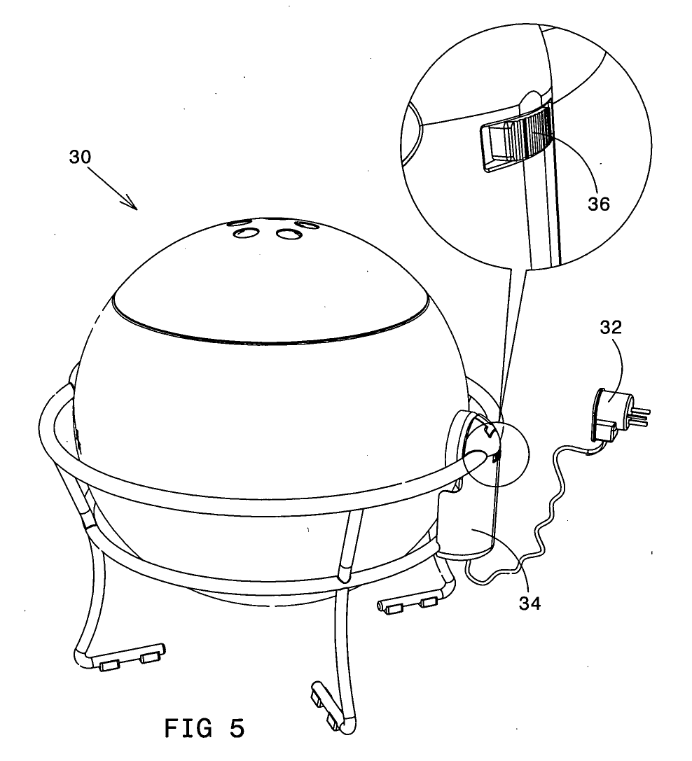

Referring to FIG. 5, illustrates an isometric schema of the round rotating cooking pot using the electric engine method (30) according to the present invention.

In the illustration it is possible to view how attached to the pot is a socket which connects to the electricity (32), which propels an engine which is covered by the engine cover (34) and on its upper part is a switch to turn on the engine (36).

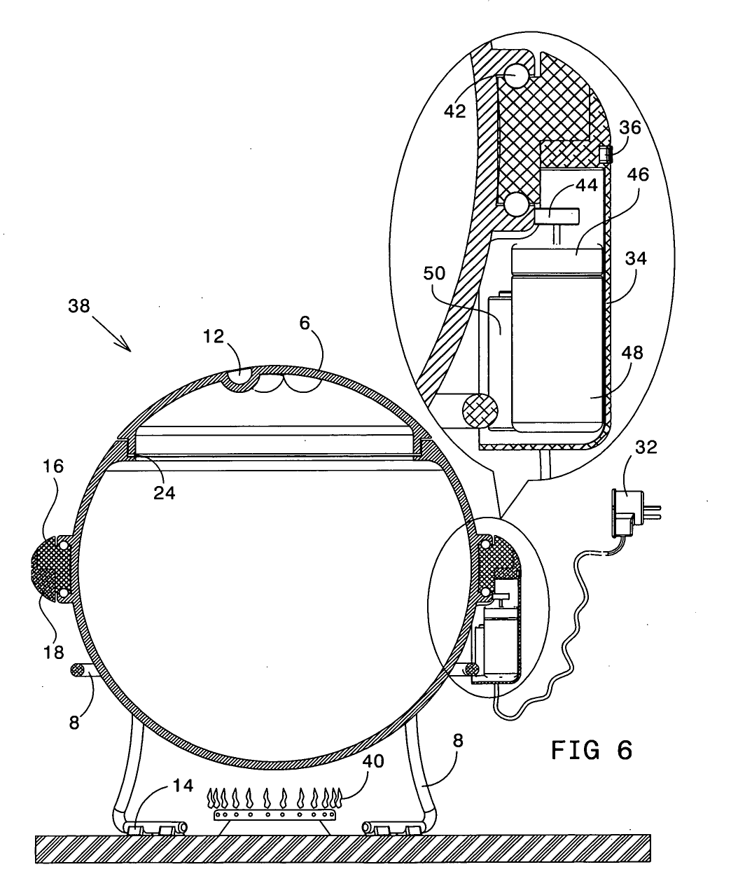

Referring to FIG. 6, illustrates a two dimensional schema of a section schema of the round rotating cooking pot using the electric engine method according to the present invention.

In this illustration the pot is set above a fire flame (40), using stand (8), which is rested above the stove top using rubber foundations for creating high friction and preventing movement and slipping (14).

The pot connects to the foundations of the connector (18) using connector (16). The pot is closed by the pot lid (6) which has holes for the fingers grip (12), furthermore, at the connection between the lid and pot is a rubber seal (24).

In the enlargement it is possible to view the engine cover (34) from which comes out a socket which connects to the electricity.

On the inside of said cover is an engine (48) on which a transmission is assembled (46) from which comes out the propelling wheel (44) which rotates the pot on the ball bearings (42).

The engine can also receive power from batteries (50) and is operated by operating switch (36).

What is claimed is:

1. A round rotating cooking pot which enables the user to cook food while moving so that the food that is cooking is separated in the cooking process occasionally from the sidewalls of the pot, enabling cooking food while rotating the pot in a manner which will not enable the food to stick to the pot and in a manner which the heat source will heat each time a different part of the pot, Wherein the pot rotates using the force of steam generated in the pot in the cooking process or by the force of an electric engine, the said pot comprises:
a. A round pot.
b. A rotating and sealed lid.
c. 2 hinges enabling the rotation of the pot.
d. A propelling system operated by steam comprising exhaust pipes.
e. One or more water containers inside the pot.
f. A stand enabling placing the pot above a heat source, such as cooking gas.

2. A round rotating cooking pot according to claim 1, rotated by the force of the steam coming out of pipes and nozzles which can be regulate the pressure going through them.

3. A round rotating cooking pot according to claim 1, operated by electric force using propulsion of an electric engine which receives its electric current from electric batteries.

4. A round rotating cooking pot according to claim 1, operated by electric force using propulsion of an electric engine which receives its electric current from an electric socket.

5. A round rotating cooking pot according to claim 1, which substantially the length of time needed for cooking shortens when using said pot.

6. A round rotating cooking pot according to claim 1, which due to the scattering of the heat and the movement of the pot during cooking, the food is cooked well, efficiently, equally and more unified.

7. A round rotating cooking pot according to claim 1, which when the user would like to cook a dish he opens the lid of the pot using indentations located on the lid inserts the food to the pot, already inside the pot is water inside the compartments designed to rotate the hinge. The pot is sealed using the lid and the pot is placed on the stove top or a heat source and cooking starts, in the cooking process the pot heats up creating steam that rotates it.

8. A round rotating cooking pot according to claim 1, which when the user would like to cook a dish he opens the lid of the pot, inserts the food to the pot, already inside the pot is water inside the compartments designed to rotate the hinge. The pot is sealed using the lid and the pot is placed on the stove top or a heat source and cooking starts, in the cooking process the pot heats up creating steam that rotates it.

9. A round rotating cooking pot according to claim 1, which rotates using the steam pressure released through the exhaust openings.

10. A round rotating cooking pot according to claim 1, which rotates using the mechanical force of an electric engine which receives its electric current from batteries.

11. A round rotating cooking pot according to claim 1, which rotates using the mechanical force of an electric engine which receives its electric current from an electric socket.

12. A round rotating cooking pot as illustrated and described above.
